(19) United States
(12) Patent Application Publication
(10) Pub. No.: US 2008/0111117 A1
(43) Pub. Date: May 15, 2008

(54) Hydraulic Jack Comprising a Safety Lock

(75) Inventor: Shenghua Wu, Hangzhou (CN)

Correspondence Address: GLOBAL IP SERVICES, 7285 W. Eagle Court, Winton, CA, 95388, US

(73) Assignee: HANGZHOU YINGJIANG MACHINERY MANUFACTURE CO. LTD., Hangzhou (CN)

(21) Appl. No.: 11/697,373

(22) Filed: Apr. 6, 2007

(30) Foreign Application Priority Data
Nov. 15, 2006 (CN) 200620140090.5

(51) Int. Cl. B66F 5/04

(52) U.S. Cl. 254/8 R

(57) ABSTRACT

A hydraulic jack comprises a safety lock. The jack includes front wheels (1a); rear casters (1b); a pair of frame plates (1); a lift arm (5) pivotally mounted on the said plates; a saddle arranged at the free end of the lift arm; a hydraulic power unit (4) mounted to the frame plates for lifting the lift arm (5); a handle (2) attached at the frame for driving the said hydraulic power unit, wherein the said handle (2) is connected to the piston of the hydraulic power unit via a handle yoke (3). A safety lock for the lift arm (5) is further provided wherein the safety lock consists of a support rod (6) pivotally attached to the lift arm and a block member (10) which is secured to the frame plates and has stop ratchet teeth capable of engaging with the bottom of the support rod (6) in its front slope surface; the said safety lock also contains a disengaging device capable of turning the support rod (6) to either the position of engaging with any of the ratchet teeth of the block member (10) or the position of disengaging from the block member (10) wherein the disengaging device includes a fork (11) capable of getting the support rod (6) rid of the ratchet tooth of the block member (10), a pedal (14) connected to the fork (11) via a linkage (12) wherein the fork (11) is designed in the way that enable it to be pushed back to its first position by the bottom side of the support rod (6) when the lift arm (5) drops back to the lowest position, and a lock means allowing the disengaging device to maintain its position after the pedal (14) is stepped down.

### CROSS REFERENCE TO THE RELATED PATENT APPLICATION

This application claims the priority right of the Chinese patent application No. 200620140090.5, filing date Nov. 15, 2006.

### FIELD OF THE INVENTION

The present invention relates to a hydraulic jack for lifting vehicles, particularly to a jack that includes both a safety lock able to prevent the possible risks when the lift arm is in motion or staying at a high position and a disengaging device capable of disengaging the support rod from the block means in time to continue lower the lift arm.

### BACKGROUND OF THE INVENTION

Usually, a jack includes a frame 1 on front wheels and rear casters, wherein on the frame mounted a handle, a handle yoke, a hydraulic power unit, a lift arm, long coupling rod, a saddle and a saddle base. Before raising the vehicle that needs repairing, put the jack under the vehicle, and then actuate the hydraulic power unit through the handle yoke by pumping the handle up and down to increase the oil pressure to raise the lift arm. Conversely, release the hydraulic power unit to lower the lift arm. However, the disadvantages of the jack are as follows: its lift arm has the risk of collapse in the event of mechanical bug or pump failure.

In order to prevent the possible accidents, China Patent 03207592.8 presents “the hydraulic jack comprising block means and safety device”, wherein a ratchet block is secured to the jack's frame plate and support rods capable of preventing the lift arm from lowering by getting engaged with the ratchet block are mounted on the lift arm. Additionally, a positioning control connected by a steel cord is adopted at the top of the handle. During the process of raising the lift arm, the positioning control pulls the support rods to move on the ratchet block so that the said support rods shall be engaged automatically with different ratchet teeth of the block when the lift arm rises to different heights. Located on the top of the handle and connected by a steel cord, the positioning control functions to disengage the support rods from the ratchet block so as to lower the lift arm. But there exists the following disadvantages: the positioning control, as the construction figure provided shows, disengages the support rods from the ratchet block by tensing the steel cord connected thereof, however, due to the lack of positioning means, the support rods shall be maintained at the disengaged position by keeping tensing the positioning control, otherwise the support rods will fall back to the ratchet block and engage with the ratchet block again, thus preventing the lift arm from lowering. Nevertheless, during the process of lowering the lift arm, operators have to keep operating the handle when it proves troublesome and hard to tighten the positioning control at the same time. Additionally, the fact that an appropriate force-exerting point is difficult to find through pulling the support rods by steel cord which however is inclined to become loose would attribute to the failure of disengaging the support rods from the ratchet block, so it is not reliable.

U.S. Pat. No. 4,289,299 presents a jack comprising a safety device that comprises a support block member, wherein the disengagement of the support block member takes place by pulling or pushing the long linkage, and a positioning means for the disengaging device, which meets the requirement of maintaining the position of the support block member while lowering the lift arm and functionally realizes the disengagement of the support block member. But operators still need to operate the safety device by hand, which is not comfortable. Also the reset of the disengaging device, namely the support block member getting rid of the positioning means, cannot complete automatically, and the operator is likely to forget to reset the disengaging device, resulting in the failure of the safety device and inadequate security when using again.

### SUMMARY OF THE INVENTION

It's an object of the present invention to overcome the aforementioned existing technology's disadvantages of inconvenience and the disengaging device being unable to reset automatically and provide an easy-to-use, reliable and safe jack comprising safety lock.

The hydraulic jack comprising a safety lock in the present invention includes front wheels la; rear casters 1b; a pair of frame plates 1; a lift arm 5 pivotally mounted on the said plates; a saddle arranged at the free end of the lift arm; a hydraulic power unit 4 mounted to the frame plates for lifting the lift arm 5; a handle 2 attached at the frame for driving the said hydraulic power unit, wherein the said handle 2 is connected to the piston of the hydraulic power unit via a handle yoke 3. A safety lock for the lift arm 5 is further provided wherein the safety lock consists of a support rod 6 pivotally attached to the lift arm and a block means 10 which is secured to the frame plates and has stop ratchet teeth capable of engaging with the bottom of the support rod 6 in its front slope surface; the said safety lock also contains a disengaging device capable of turning the support rod 6 to either the position of engaging with any of the ratchet tooth of the block member 10 or the position of disengaging from the block member 10 wherein the disengaging device includes a fork 11 capable of getting the support rod 6 rid of the ratchet tooth of the block member 10 a pedal 14 connected to the fork 11 via a linkage 12 wherein the fork 11 is designed in the way that enable it to be pushed back to its first position by the bottom side of the support rod 6 when the lift arm 5 drops back to the lowest position, and a positioning means allowing the disengaging device to maintain its position after the pedal 14 is stepped down.

Further, the top surface of the said fork 11 takes on a concave shape that is identical to the path-line the bottom of the support rod 6 goes by in the process of rising or lowering. When the lift arm lowers, the bottom of the support rod 6 is in contact with the top surface of the fork 11

Furthermore, the fork 11 is pivotally connected with one end of the linkage 12, the other end of which is pivotally connected with the pedal 14.

Additionally, it is contemplated that the said positioning means can be composed of snap spring band 13 or friction block or retaining ring. During the process of raising the lift arm 5, the bottom of the support rod 6 is pulled on the ratchet of the block member 10 at the gravity of the support rod 6 itself when in case of the an incident such as the failure of the hydraulic power unit 4, the support rod 6 will immediately sustain the loaded lift arm, preventing the accident from happening. To lower the lift arm, step the pedal 14 down to tilt the fork 11 upwardly, allowing the bottom of the support rod 6 to get rid of the ratchet of the block member; meantime the positioning means maintains the position of the whole set of the disengaging device. Therefore, during the process of lowering the lift arm, the bottom of the support rod 6 is gliding upon the top surface of the fork 11 instead of falling back to the ratchet of the block member 10 to prohibit the lift arm from lowering. When the lift arm is about to return to its lowest height, the support rod 6 starts to press the top surface of the fork 11 downwardly, forcing to set the disengaging device free from the lock means, so the o the disengaging device resets automatically.

The benefits of the present invention are as follows: 1. It's easy to use as it only needs to step down the pedal to lower the lift arm, freeing operators' hands. 2. The disengaging device is able to reset automatically, which proves convenient, enhances the security, and eradicates the risk brought about by forgetting to reset the disengaging device. 3. The fork is of reliable and reasonable design, which proves efficient on sustaining the load and functional under the support rod.

### BRIEF DESCRIPTION OF THE DRAWING

In order that the present invention may be better understood, a preferred embodiment thereof will now be described with reference to the accompanying drawings, in which:

FIG. 1 is a view of a jack with the lift arm at the raised position made in accordance with present invention.

FIG. 2 is a view of a jack with the lift arm at its lowest position made in accordance with the present.

FIG. 3 is a top plan view of a jack made in accordance with the present invention.

FIG. 4 is a sketch figure showing that step the pedal 14 down to raise the fork 11, the bottom end of the support rod 6 moves the ratchet tooth of block member 10 out.

FIG. 5 is a sketch figure showing the cooperation between the pedal 14 and the snap spring band 13.

FIG. 6 is a K direction view of the FIG. 5.

FIG. 7 is a sketch figure showing the cooperation between the snap spring band 13 and the fork 11.

FIG. 8 is a sketch figure showing the cooperation between the snap spring band 13 and the linkage 12.

FIG. 9 is a sketch figure showing the cooperation between the pedal 14 and the friction block 13a.

FIG. 10 is a K direction view of FIG. 9.

FIG. 11 is a sketch figure showing the cooperation between the pedal 14 with the retaining ring 13b.

FIG. 12 is a K direction view of FIG. 11.

Referring to the drawings, the same numerals denote the same parts: 1—frame plates; 1a—front wheel; 1b—rear caster; 2—handle; 3—handle yoke; 4—hydraulic power unit; 5—lift arm; 5a—bolt; 6—support rod; 7—long coupling rods; 8—saddle; 9—saddle base; 10—block member; 11—fork; 12—linkage; 13—snap spring band; 14—pedal.

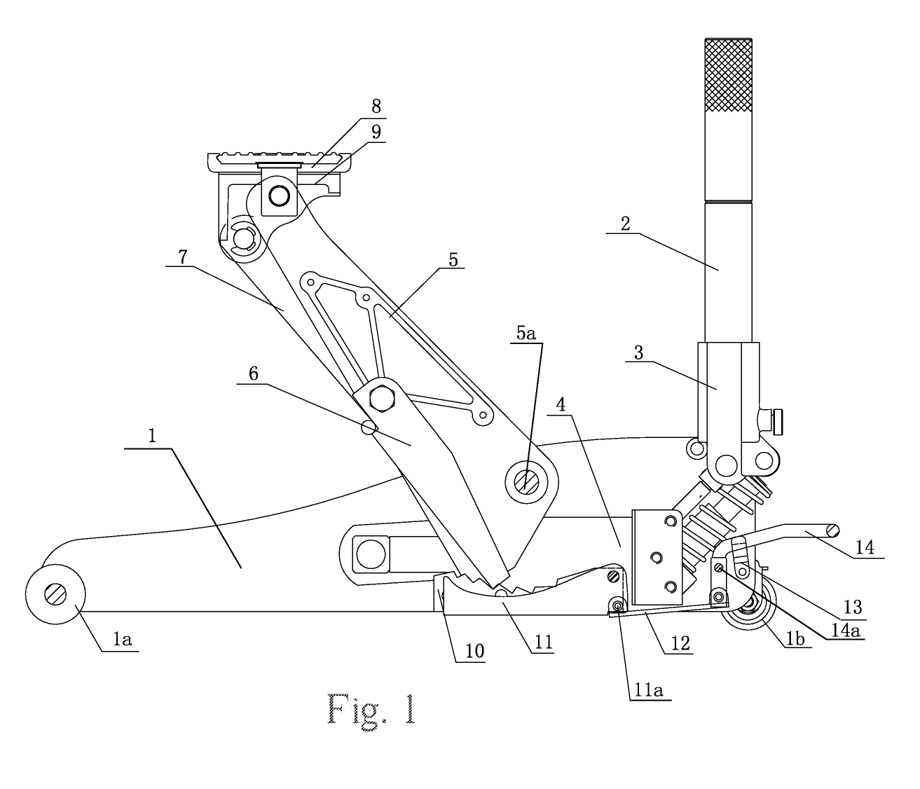

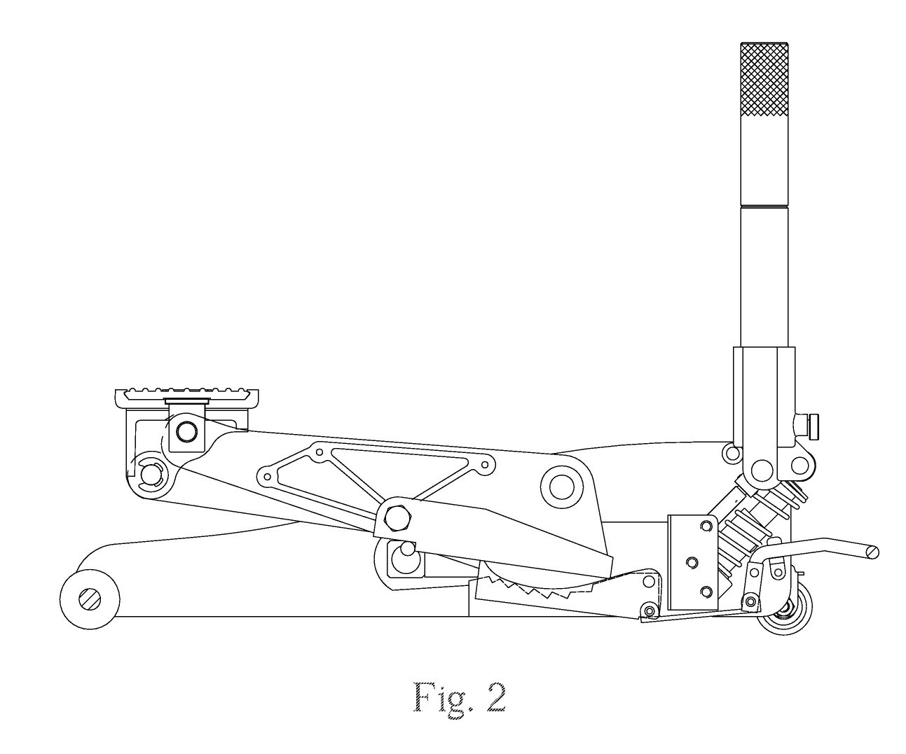

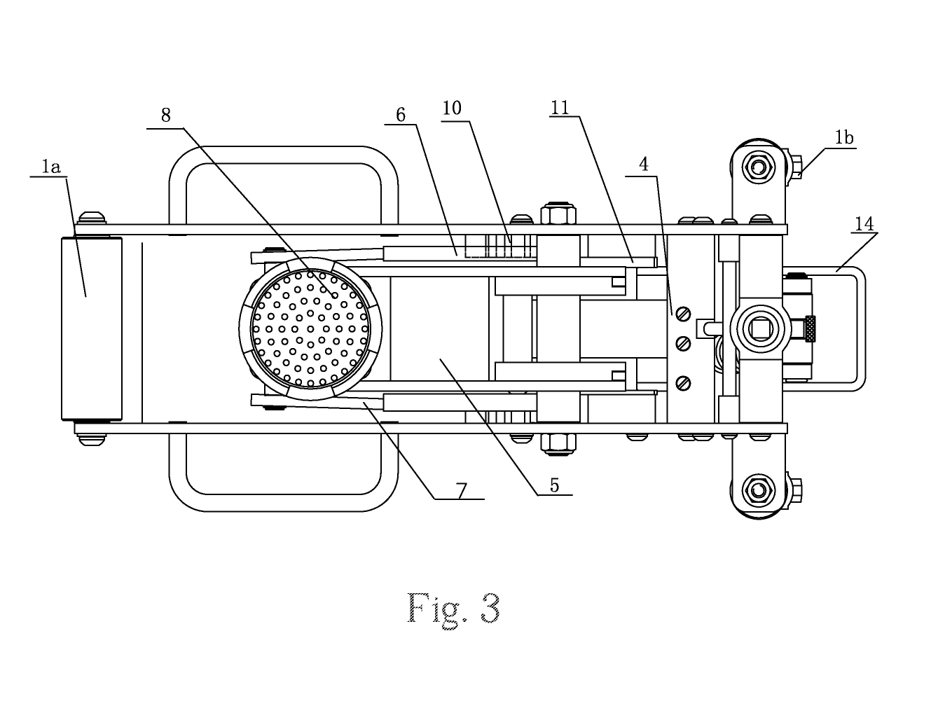

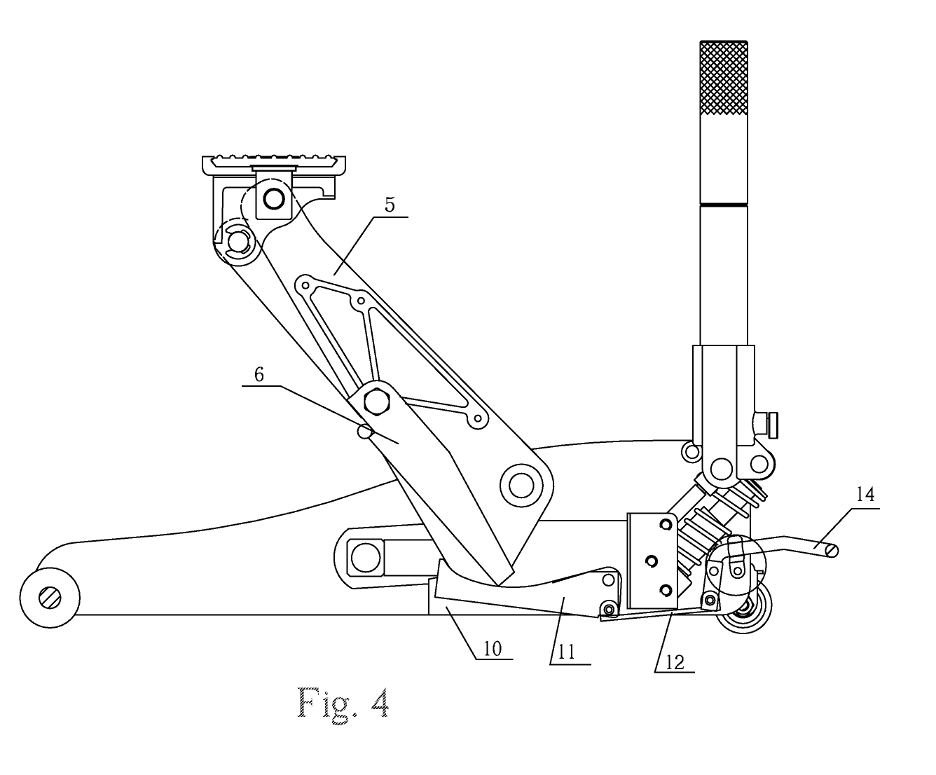

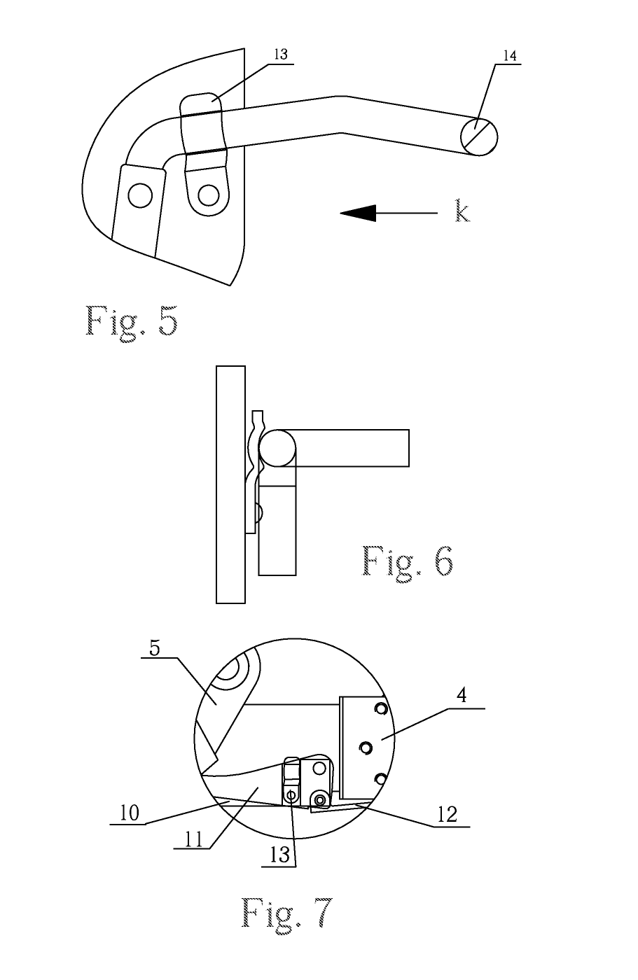

As the FIG. 1, FIG. 2 or FIG. 3 shows, the safety jack made in accordance with the embodiment includes front wheels 1a and rear casters 1b; a pair of frame plates 1; a lift arm 5 pivotally mounted on the said plates; a saddle arranged at the free end of the lift arm; a hydraulic power unit 4 mounted to the frame plates for lifting the lift arm 5; a handle 2 attached at the frame for driving the said hydraulic power unit, wherein the said handle 2 is connected to the piston of the hydraulic power unit via a handle yoke 3. A safety lock for the lift arm 5 is further provided wherein the safety device consists of a support rod 6 pivotally attached to the lift arm and a block member 10 which is secured to the frame plates and has stop ratchet teeth capable of engaging with the bottom of the support rod 6 in its front slope surface; the said safety lock also contains a disengaging device capable of turning the support rod 6 to either the position of engaging with any of the ratchet tooth of the block member 10 or the position of disengaging from the block member 10 wherein the disengaging device includes a fork 11 capable of getting the support rod 6 rid of the ratchet tooth of the block member 10, a pedal 14 connected to the fork 11 via a linkage 12 wherein the fork 11 is designed in the way that enable it to be pushed back to its first position by the bottom side of the support rod 6 when the lift arm 5 drops back to the lowest position, and a positioning means allowing the disengaging device to maintain its position after the pedal 14 is stepped down.

A ratchet is adopted and used as the engagement means of the block member 10 in this embodiment.

The top surface of the said fork 11 takes on a concave shape that is identical to the path-line the bottom of the support rod 6 goes by in the process of rising or lowering. When the lift arm lowers, the bottom of the support rod 6 is in contact with the top surface of the fork 11. The fork 11 is pivotally connected with one end of the linkage 12, the other end of which is pivotally connected with the pedal 14. It is contemplated that the said positioning means is essentially a snap spring band or a friction block or a retaining ring.

The hydraulic power unit in this embodiment is of conventional structure. Initiated by a handle 2, the hydraulic power unit 4 comprises a linkage block, the front of which is pivotally connected to the lift arm 5. To raise the lift arm 5, actuate the hydraulic power unit via the handle yoke 3 by pumping the handle 2 up and down when the hydraulic power unit 4 drives the linkage block to move forward, therefore the lift arm rises.

The lift arm 5 is of conventional structure as well. The lift arm 5 composed of a main arm and long coupling rods wherein the one end of the main arm is pivotally attached to the frame plates while the other end pivotally connected to the saddle base. During the process of raising the lift arm 5 the saddle keeps horizontal due to the parallelogram effect.

While raising the lift arm, the bottom of the support rod 6 pivotally attached to the lift arm 5 via the bolt 5a moves on the block member 10 from right hand side to left hand side, once the lift arm stops rising, the bottom of the support rod 6 will immediately engaged with one of the ratchet teeth of the block member to sustain the lift arm, as the FIG. 1 shows the support rod gets engaged with the block member.

To lower the lift arm, step the pedal 14 downwardly when the pedal 14 is pivoted around its pivot point 14a, which turns the fork 11 around its pivot point 11a, so the left portion of the fork 11 tilts upwardly, which pushes the support rod 6 slightly, turning it counterclockwise around the bolt 5a slightly with the result of being disengaged from the ratchet of the block member, as the FIG. 3 shows that the support rod 6 gets rid of the block member 10. Then the lift arm lowers.

Snap spring band 13 capable of locking the pedal 14 is further provided on the frame. The pedal 14 is locked by the snap spring band after it is stepped down and the position of the whole disengaging device is maintained thereby so that the support rod 6 will be kept away from the ratchet of the block member and drop smoothly all the while during the process of lowering the lift arm. Operators do not have to step the pedal continuously before the lift returns to its lowest height. The snap spring band 13 essentially constitutes the Positioning means of the disengaging device.

Refer to FIGS. 9-10 the positioning means may be composed of friction block 13a

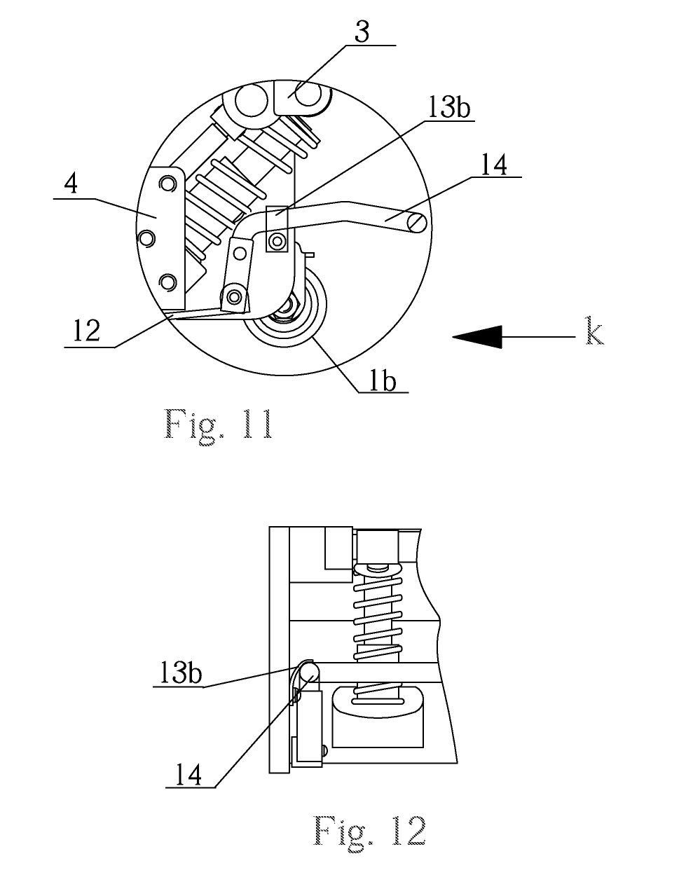

Refer to FIGS. 11-12 the positioning means may be composed of retaining ring 13b.

The top surface of the said fork 11 takes on a concave shape which proves identical to the path-line that the bottom of the support rod 6 goes by during the process of rising or lowering. The bottom of the support rod 6 is gliding upon the top surface of the fork 11 during the process of lowering the lift arm.

When the lift arm is about to return to its lowest height, the support rod 6 starts to press the top of the fork 11 downwardly, forcing the pedal 14 to get rid of the snap spring band 13, and the reset of the disengaging device completes. Therefore, the operator do not have to reset the disengaging device on purpose to ensure the bottom of the support rod 6 to engage with the ratchet of the block member at the gravity of the support rod itself when using again.

In the embodiment 2, all the parts and construction are the same with the embodiment 1 except that the positioning means of the disengaging device. Refer to the FIG. 7, the snap spring band 13 is provided within the pivoted reach of the fork 11 and functions cooperatively with the fork 11.

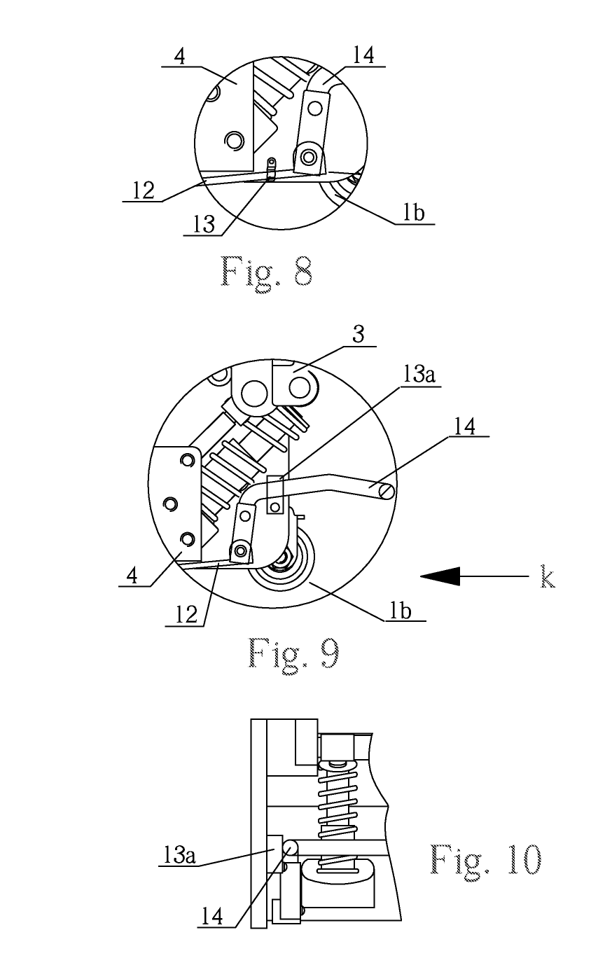

In the embodiment 3, all the parts and construction are the same with the embodiment 1 except that the positioning means of the disengaging device. Refer to the FIG. 8 the snap spring band 13 is provided within the pivoted reach of the linkage 12 and functions cooperatively with linkage 12.

Although the present invention has been described in some detail by way of illustration and example for purposes of clarity of understanding, it will, of course, be understood that various changes and modifications may be made in the form, details, and arrangements of the parts without departing from the scope of the invention as set forth in the following claims.

1. A hydraulic jack comprising a safety lock, front wheels, rear casters, a pair of frame plates, a lift arm, a saddle, a hydraulic power unit, a handle, further comprising:
a handle yoke connecting said handle to a piston of said hydraulic power unit;
a safety lock means for the lift arm comprising a support rod pivotally attached to said lift arm, a block member secured to the frame plates having stop ratchet teeth for engaging with a bottom of said support rod, thereby, while said lift arm raising the bottom of said support rod slides on said stop ratchet teeth, once said lift arm stops rising the bottom of said support rod immediately engages with one of the stop ratchet teeth of said block member to sustain said lift arm for safety;
a disengaging device having a fork for turning said support rod to either a position of engaging with said ratchet teeth or a position of disengaging from said block means, a pedal connected to said fork via a linkage;
said fork having a concave top surface being identical to a path-line tracked by the end of said support rod while lowering said lift arm, thereby the concave top surface lets the end of said support rod sliding on its top surface without touching said ratchet teeth and lets said support rod pushing the fork back to its original position when said lift arm dropping back to a lowest position;
a positioning means for maintaining the fork of said disengaging device at a rising position to continuingly separate said support rod from the stop ratchet teeth after releasing step on the pedal.

2. (canceled)

3. The hydraulic jack of claim 1, wherein said fork is pivotally connected with one end of said linkage, other end of the linkage is pivotally connected with said pedal.

4. (canceled)

5. The hydraulic jack of the claim 1, wherein said positioning means is a snap spring band.

6. The hydraulic jack of claim 5, wherein the said positioning means is provided on the frame and acts cooperatively with said pedal.

7. The hydraulic jack of claim 5, wherein the said positioning means is provided on the frame and acts cooperatively with said linkage.

8. The hydraulic jack of claim 5, wherein the said positioning means is provided on the frame and acts cooperatively with said fork.

9. The hydraulic jack of claim 1, wherein said positioning means is a friction block.

10. The hydraulic jack of claim 1, wherein said positioning means is a retaining ring
